(19) United States
(12) Patent Application Publication
(10) Pub. No.: US 2009/0018902 A1
(43) Pub. Date: Jan. 15, 2009

(54) COMMUTER CREDITS SYSTEM AND METHOD

(76) Inventors: Jannine Miller, Atlanta, GA (US); David Weir, Atlanta, GA (US); Patrick Vu, Atlanta, GA (US); Teresa Slack, Atlanta, GA (US); John Breedlove, Alpharetta, GA (US); Randall Guensler, Atlanta, GA (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/170,366

(22) Filed: Jul. 9, 2008

Related U.S. Application Data
(60) Provisional application No. 60/958,762, filed on Jul. 9, 2007.

(51) Int. Cl. G07B 15/00

(52) U.S. Cl. 705/13

(57) ABSTRACT

Disclosed are systems and methods for implementing a Commuter Credit Program that allows commuters and non-commuters to generate credits that may be redeemed as cash on tollway system or for other benefits. Exemplary systems and methods identify participants or a proxy account ID at various locations on the transportation system or at other prescribed locations to qualify the participant and issue commuter credit. Similarly, exemplary systems and methods positively identify participants at various locations in the transportation system such that the credits can be used in lieu of paying cash on the tollway or at other prescribed locations to receive alternative benefits.

### CROSS REFERENCE TO RELATED PATENT APPLICATIONS

This application claims priority to and benefit of U.S. Provisional Application No. 60/958,762 filed Jul. 9, 2007, which is fully incorporated herein by reference in its entirety and made a part hereof.

### BACKGROUND

Transportation congestion is a significant problem in most urban areas in the United States, where many trips are conducted in single-occupant vehicles. Alternative commute modes (carpools, transit, etc.) and methods (telecommuting, remote worksite locations, etc.) are often not sought by individual workers due to the likelihood of increased travel times and inconvenience. Instituting alternative work hours and telework programs are often not embraced by employers because of managers' perceived disruption to regular work flow and/or skepticism in workers' ability to be productive.

With rising fuel prices, commuter traffic congestion and pollution concerns, alternative commute modes and methods are becoming more attractive to commuters and employers. Alternative commute modes may be adopted more readily by commuters and employers if incentives are provided for commute alternatives, or disincentives imposed for those choosing to not participate in alternative commute modes and methods.

Therefore, what is desired are systems and methods that overcome challenges found in the art, some of which are described above.

### SUMMARY

Disclosed herein are methods and systems for the implementation of a commuter credits program to encourage the use of alternative transportation modes and methods. The methods and systems yield a program that generates commuter credits in return for using alternative transportation modes (carpools, vanpools, transit, etc.), commuting to work during off-peak or uncongested periods, participating in telecommuting or remote worksite programs, or participating in other approved programs designed to reduce travel during peak traffic periods of the day. Similarly, an account of credits can be debited for ignoring or choosing not to participate in alternative transportation modes, travel during peak traffic periods, etc., as described herein. Embodiments allow users to redeem their commuter credits for the payment of tolls, for gasoline or parking costs, or for conversion to dollar amounts, transit fares, merchandise, or a variety of other premiums that may have an economic value.

Embodiments of a commuter credits program can provide tangible rewards for individual workers to seek and choose a commuting alternative. One goal of a commuter credits program is to provide a reward program that appropriately motivates a shift in commute patterns to alternate travel times and/or travel modes, reducing peak period congestion. Such a program may also address equity concerns that stem from the perception that only wealthy individuals can afford to pay to use a priced facility such as an express lane, available only to those willing to pay a toll, because embodiments of the program allow anyone to generate credits for use within the system.

In one aspect, an electronic commuter credits system is described. The system comprises a processor, and an electronic barrier system. The electronic barrier system further comprises at least a plurality of sensing devices located in series along one or more lanes of travel of a roadway system. The plurality of sensing devices are operably connected to the processor. The electronic barrier system is configured to detect a presence or absence of a vehicle in one or more lanes of travel of a roadway system and positively identify the vehicle. Further comprising the commuter credits system is a memory. Commuter credits are assessed to a registered owner of the vehicle or a passenger in the vehicle, or tolls or fees are assessed to the registered owner of the vehicle or a passenger in the vehicle based upon patterns of travel of the vehicle, and said commuter credits are stored in the memory in a commuter credits account associated with an individual.

In another aspect, a method of tracking that facilitates participant identification for association with a commuter credit account to which commuter credits can be credited or debited. The method comprises linking a commuter credit account with a participant. The linking comprises pre-registration of individual commuter credit accounts with vehicle identification numbers or implementation of in-vehicle sensors configured for reading account numbers for each participant using said the registered vehicle. The vehicle is identified on a roadway or the absence of the vehicle is identified on the roadway. The vehicle is associated with one or more individual commuter credit accounts. Based upon pre-defined parameters and the presence or absence of the vehicle on the roadway, it is determined whether to credit or debit one or more individual commuter credit accounts associated with the vehicle.

In yet another aspect, a method of managing a commuter credit account is described. The method comprises linking a commuter credit account with a participant. The participant is detected using, or not using, alternative transportation modes or methods. The participant's commuter credit account is credited or debited based upon the participant's using, or not using, alternative transportation modes or methods.

Additional advantages will be set forth in part in the description which follows, or may be learned by practice. It is to be understood that both the foregoing general description and the following detailed description are exemplary and explanatory only and are not restrictive.

### BRIEF DESCRIPTION OF THE DRAWINGS

Various features and advantages of the present invention may be more readily understood with reference to the following detailed description taken in conjunction with the accompanying drawings, which are not drawn to scale, wherein like reference numerals designate like structural elements, and in which:

FIG. 1 illustrates a simplified, non-limiting block diagram showing select components of a system according to one embodiment;

FIG. 2 illustrates a simplified, non-limiting example of a vehicle entering and exiting a controlled lane at permissible locations where monitoring stations and associated recording devices record the progress of the vehicle;

FIG. 3 illustrates a simplified, non-limiting example of a vehicle entering and exiting a controlled lane at restricted locations where monitoring stations and associated recording devices record the progress of the vehicle;

FIG. 4 illustrates a simplified, non-limiting example of expanding the electronic barrier and automated enforcement system to existing general purpose lanes;

FIGS. 5A and 5B illustrate a simplified, non-limiting example of using the electronic barrier and automated enforcement system for multipurpose lanes;

FIG. 6 illustrates a simplified, non-limiting block diagram of some logical components of the electronic barrier and automated enforcement system;

FIG. 7 illustrates an exemplary flow chart describing the steps to implement the method used by the electronic barrier and automated enforcement system, according to one embodiment;

FIG. 8 illustrates an exemplary flow chart describing the steps to implement the method used by the commuter credit program to issue traffic citations, according to one embodiment;

FIG. 9 illustrates another exemplary flow chart describing the steps to implement the method used by the commuter credit program to update commuter credit accounts, according to one embodiment;

FIG. 10A is a flowchart that illustrates the steps of managing a commuter credit account according to one embodiment; and

FIG. 10B is a flowchart that illustrates the steps of implementing tracking that facilitates participant identification for association with a commuter credit account to which commuter credits can be credited or debited, according to embodiments.

### DETAILED DESCRIPTION

The present embodiments may be understood more readily by reference to the following detailed description of the embodiments and the examples included therein and to the figures and their previous and following description.

Before the present systems, articles, devices, and/or methods are disclosed and described, it is to be understood that this description is not limited to specific systems, specific devices, or to particular methodology, as such may, of course, vary. It is also to be understood that the terminology used herein is for the purpose of describing particular embodiments only and is not intended to be limiting.

The following description is provided as an enabling teaching of the system and method in its best, currently known embodiment. To this end, those skilled in the relevant art will recognize and appreciate that many changes can be made to the various aspects of the systems and methods described herein, while still obtaining the beneficial results of the present systems and methods. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used in the specification and the appended claims, the singular forms “a,” “an” and “the” include plural referents unless the context clearly dictates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed, the “less than or equal to 10” as well as the “greater than or equal to 10” is also disclosed. It is also understood that throughout the application, data is provided in a number of different formats and that this data represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

“Optional” or “optionally” means that the subsequently described event or circumstance may or may not occur, and that the description includes instances where said event or circumstance occurs and instances where it does not.

“Exemplary,” where used herein, means “an example of” and is not intended to convey a preferred or ideal embodiment. Further, the phrase “such as” as used herein is not intended to be restrictive in any sense, but is merely explanatory and is used to indicate that the recited items are just examples of what is covered by that provision.

As will be appreciated by one skilled in the art, the present invention may be embodied as a method, a system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

Embodiments of the present invention are described below with reference to block diagrams and flowchart illustrations of methods, systems, apparatuses and computer program products according to an embodiment of the invention. It will be understood that some blocks of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture, including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

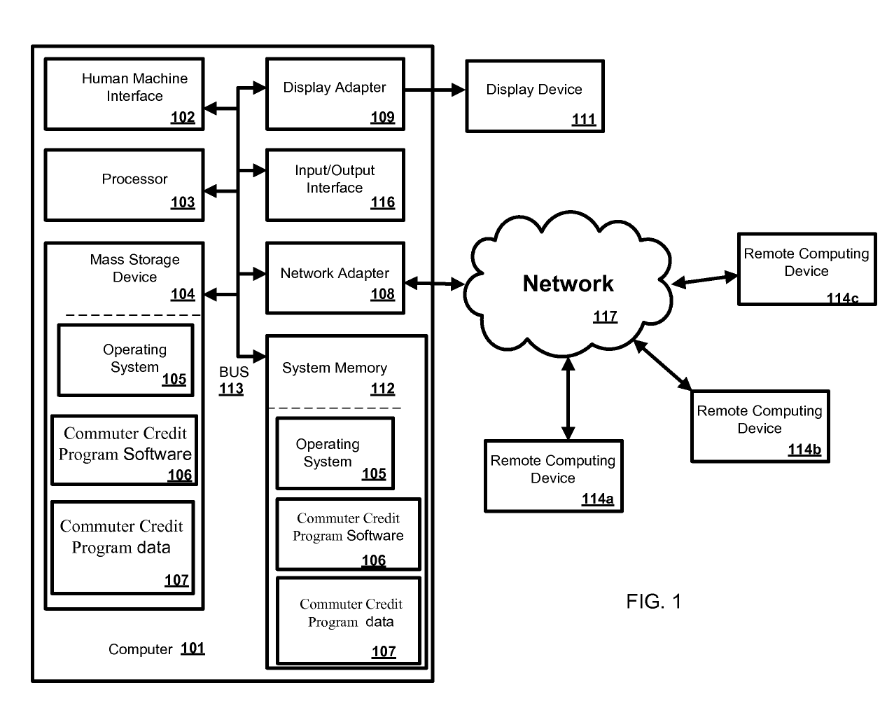

FIG. 1 is a block diagram illustrating an exemplary operating environment for performing the disclosed method. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, hand-held electronic devices, vehicle-embedded electronic devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 113, and all buses specified in this description can also be implemented over a wired or wireless network connection and each of the subsystems, including the processor 103, a mass storage device 104, an operating system 105, Commuter Credit Program software 106, Commuter Credit Program data 107, a network adapter 108, system memory 112, an Input/Output Interface 116, a display adapter 109, a display device 111, and a human machine interface 102 that can include a graphical user interface (GUI), can be contained within one or more remote computing devices 114a,b,c at physically separate locations, connected through buses of this form, in effect implementing a fully distributed system.

The computer 101 typically comprises a variety of computer-readable media. Exemplary readable media can be any available media that is accessible by the computer 101 and comprises, for example and not meant to be limiting, both volatile and non-volatile media, removable and non-removable media. The system memory 112 comprises computer-readable media in the form of volatile memory, such as random access memory (RAM), and/or non-volatile memory, such as read only memory (ROM). The system memory 112 typically contains data such as Commuter Credit Program data 107 and/or program modules such as operating system 105 and Commuter Credit Program software 106 that are immediately accessible to and/or are presently operated on by the processing unit 103.

In another aspect, the computer 101 can also comprise other removable/non-removable, volatile/non-volatile computer storage media. By way of example and not meant to be limiting, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example and not meant to be limiting, an operating system 105 and Commuter Credit Program software 106. Each of the operating system 105 and Commuter Credit Account software 106 (or some combination thereof) can comprise elements of the programming and the Commuter Credit Program software 106. Commuter Credit Program data 107 can also be stored on the mass storage device 104 as binary data, text data or in a database. Commuter Credit Program data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. By way of example and not meant to be limiting, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 116. Any step and/or result of the methods can be output in any form to an output device.

The computer 101 can operate in a networked environment using logical connections to one or more remote monitoring stations or computing devices 114a,b,c. By way of example and not meant to be limiting, a remote computing device can be a personal computer, portable computer, a server, a router, a network computer, a peer device or other common network node, virtual platform, and so on. Logical connections between the computer 101 and a remote monitoring station or computing device 114a,b,c can be made via wired networks, wireless networks or combinations thereof including a local area network (LAN or WLAN), a general wide area network (WAN or WWAN), virtual private networks (VPN), leased private networks, or any other network or ad-hoc, peer-to-peer communications process. Such network connections can be through a network adapter 108. A network adapter 108 can be implemented in both wired and wireless environments. Such networking environments are conventional and commonplace in offices, enterprise-wide computer networks, intranets, and across networks 117 such as the Internet. Messaging protocols, as are known to one of ordinary skill in the art, can be used for communications throughout the network 117.

For purposes of illustration, application programs and other executable program components such as the operating system 105 are illustrated herein as discrete blocks, although it is recognized that such programs and components reside at various times in different storage components of the computing device 101, and are executed by the data processor(s) 103 of the computer. An implementation of Commuter Credit Program software 106 can be stored on or transmitted across some form of computer-readable media. Any of the disclosed methods can be performed by computer-readable instructions embodied on computer-readable media. Computer-readable media can be any available media that can be accessed by a computer. By way of example and not meant to be limiting, computer-readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., genetic algorithms), swarm intelligence (e.g., ant algorithms), and hybrid intelligent systems (e.g., Expert inference rules generated through a neural network or production rules from statistical learning).

Disclosed are commuter credit methods and systems. Embodiments of the systems and methods can be implemented with high-occupancy vehicle (HOV) and high-occupancy tollway (HOT) systems. Embodiments of electronic barrier systems, as described herein, reduce the need for a physical barrier between HOV/HOT and general purpose lanes and also addresses enforcement through the implementation of automated electronic enforcement of barrier integrity. The methods and systems of an electronic barrier system may also be used in conjunction with aspects of commuter credit programs for the promotion of various commuting options.

In one embodiment, the methods and systems include a set of monitoring stations placed at strategic locations along the HOV/HOT lane or other controlled lane to record the presence of vehicles at each station. As a vehicle in a plurality of vehicles pass the location of the monitoring station, the monitoring station records the identity of the vehicle. By monitoring progressive vehicle locations along the set of stations, the ingress or egress point of a vehicle into or out of a controlled lane may be determined.

In another embodiment, the monitoring stations may be placed relative to segments of roadway where ingress or egress to/from controlled lanes is prohibitive, to allow for the detection of vehicles that have crossed into the controlled lane at restricted or prohibitive locations.

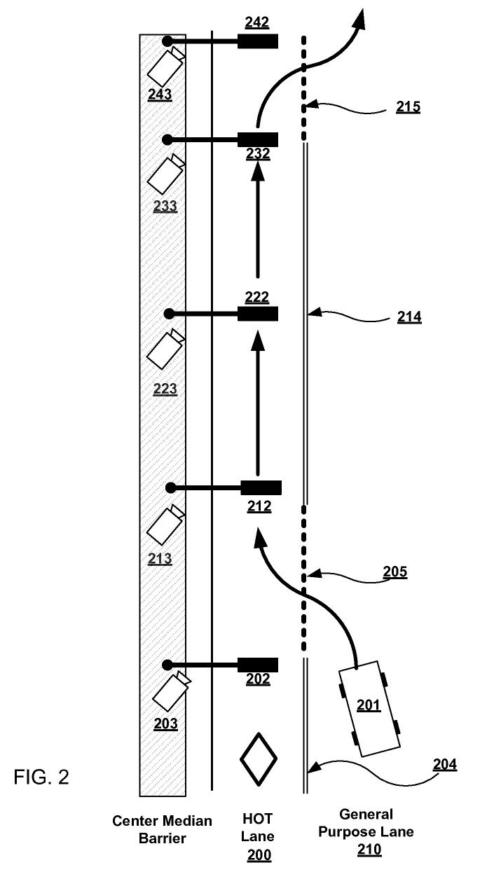

FIG. 2 illustrates a simplified non-limiting example of how the methods and systems track vehicles in a controlled lane 200. In this illustration, a segment of a roadway consists of two intervals 204, 214 where ingress/egress to/from the controlled lane 200 is restricted and two intervals 205, 215 where ingress/egress to/from the controlled lane 200 is permitted. A first vehicle 201 in a plurality of vehicles enters the controlled lane 200 at a permitted location 205 along the roadway. As the first vehicle 201 passes the location of a monitoring station 212 the identity of the vehicle 201 can be recorded by an associated recording device 213. A monitoring station 212 can be comprised of a sensing device that sense the presence of a vehicle, an identity device that can be used to identify a vehicle (i.e., read its license plate, receive a transmission from the vehicle that identifies the vehicle, etc.), or a combination of a sensing device and an identity device. In one aspect, a sensing device and an identity device can be the same device, such as a camera. In some instances, a monitoring station 212 can be a “dummy” station that makes the operator of a vehicle believe that their presence in a controlled lane is being monitored or recorded.

By examining the records of the set of monitoring stations 202, 212, 222, 232, 242, the approximate location of the first vehicle's 201 entry and exit to/from the controlled lane 200 may be determined. The first vehicle's 201 entry point may be determined by identifying the first monitoring station 212 which recorded the first vehicle 201. In FIG. 2, the first vehicle 201 is recorded by the monitoring station 212 after it has entered the controlled lane 200. Because the previous monitoring station 202 did not record the first vehicle 201 passing that location, the system may determine that the first vehicle entered the controlled lane between those two monitoring stations 202, 212. The first vehicle 201 is also recorded as passing other monitoring stations 222, 232 subsequent to entering the controlled lane 200. However, the monitoring station 242 after the point at which the first vehicle 201 exited the controlled lane 200 does not record the first vehicle 201. Because the subsequent monitoring station 242 does not record the first vehicle 201 passing that location, the system may determine that the first vehicle 201 exited the controlled lane between those two monitoring stations 232, 242.

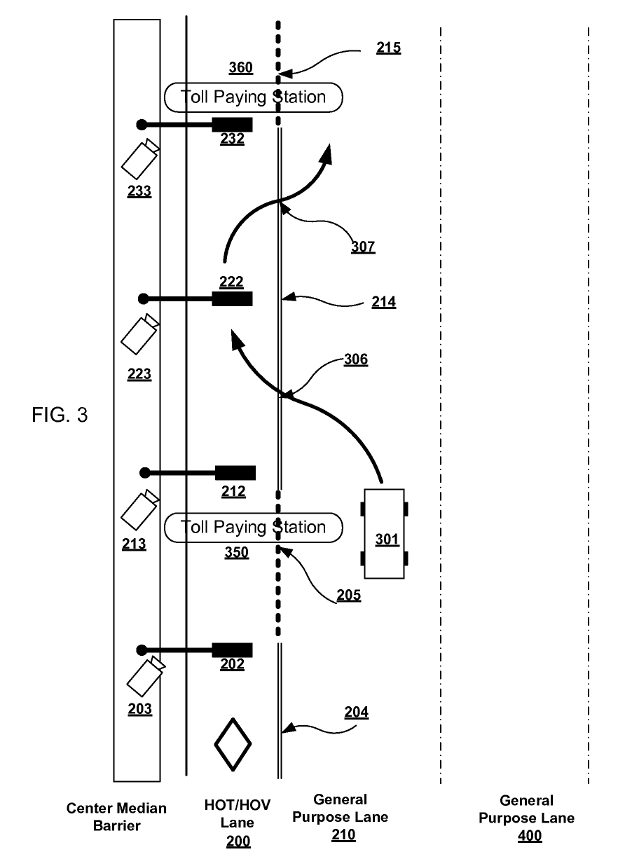

FIG. 3 illustrates a simplified non-limiting example of how the methods and systems track vehicles entering or exiting a controlled lane 200. In this illustration, the segment of the roadway consists of two intervals 204, 214 where ingress/egress to/from the controlled lane 200 is prohibited and two intervals 205, 215 where ingress/egress to/from the controlled lane 200 is permitted. A second vehicle 301 in the plurality of vehicles enters the controlled lane 200 at a location between two monitoring stations 212, 222. The second vehicle 301 is recorded by one monitoring station's 222 associated recording device 223 as the vehicle passes the location of that monitoring station 222. The second vehicle then exits the controlled lane 200 before passing the next monitoring station 232. Since the second vehicle was not in the controlled lane 200 when it passed the next monitoring station 232, the next monitoring station 232 does not record the second vehicle 301.

Because the previous monitoring station 212 did not record the second vehicle 301 passing that location, the system may determine that the second vehicle 301 entered the controlled lane between those two monitoring stations 212, 222. Because the subsequent monitoring station 232 did not record the second vehicle 301 passing that location, the system may determine that the second vehicle 301 exited the controlled lane between the two monitoring stations 222, 232. To increase the likelihood of detection of vehicles which may enter and exit a controlled lane, additional intermediate monitoring stations 222 may be deployed between permitted entry and exit locations on the controlled lane.

In one embodiment, the entry and exit locations of a vehicle may be used to determine if the vehicle's change in lanes was permissible. As illustrated in FIG. 2 and FIG. 3, by locating monitoring stations at the beginning and end of stretches of roadway where lane changes into our out of a controlled lane is regulated, the methods and systems may determine on what part of the roadway the lane change was made and whether that stretch of roadway permits such lane changes. By way of example and not meant to be limiting, it may be determined that the second vehicle 301 in FIG. 3 has entered and exited the controlled lane 200 at prohibitive locations 306, 307 because the monitoring stations 212, 232 in FIG. 3 are located at the beginning and end of a section of the roadway where lane changes are prohibitive and those monitoring stations 212, 232 did not record the second vehicle passing those locations while the intermediate monitoring station 222 did record the second vehicle passing that location.

In one embodiment, when a vehicle is identified as having entered the controlled lane illegally, the system may record the identity of the vehicle for enforcement purposes through manual observation or via technology implementation. By way of example and not meant to be limiting, a human operator may record the license plate or photograph the vehicle from a roadside station, an automated license plate identification system may use video capture to record and identify the vehicle's license plate or a roadside electronic identification system may record an identification signal broadcast from the vehicle, to name but a few non-limiting examples. A citation for the violation may then be mailed or electronically remitted to the driver or other responsible individuals if a traffic violation has occurred.

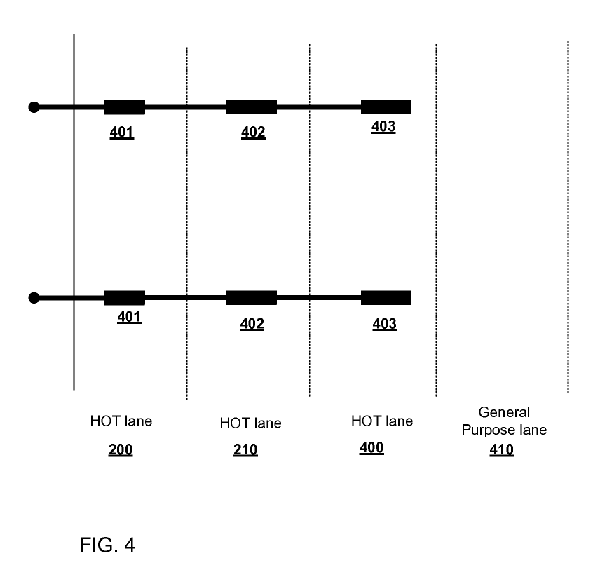

In one embodiment, the electronic barrier system provides scalability. The monitoring stations may extend over or into additional lanes as they are converted to HOV/HOT lanes with minimal engineering retrofits. By way of example and not meant to be limiting, FIG. 4 illustrates the expansion of the electronic barrier and automated enforcement system with minimal impact on additional roadway space or requirements for physical barrier systems. By adding more monitoring stations to existing general purpose lanes 210, 400, these lanes may be converted to HOV/HOT lanes.

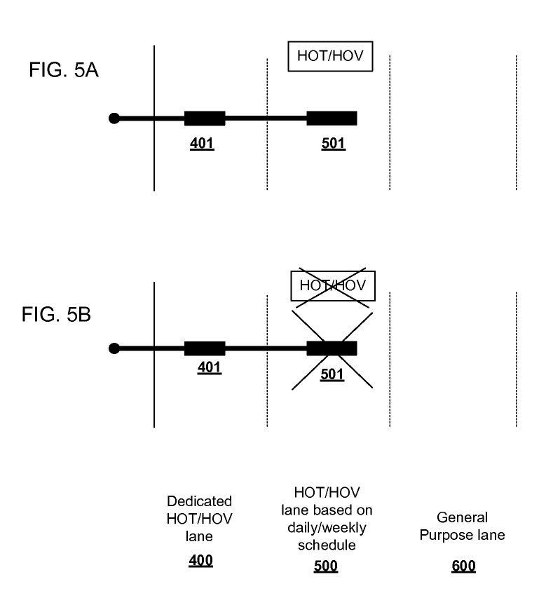

In yet another embodiment, the methods and systems may be used to create multipurpose lanes. By way of example and not meant to be limiting, FIG. 5A and FIG. 5B illustrate the usage of the methods and systems described herein to create multi-purpose lanes, according to one embodiment. These illustrations show one dedicated HOV/HOT lane 400, one multipurpose lane 500 and one general purpose lane 600. The multipurpose lane 500 may be designated as a HOV/HOT lane or a general purpose lane depending on a variety of factors. By way of example and not meant to be limiting, the multipurpose lane 500 may be designated as a HOV/HOT lane during various periods of the day or week such as mornings, afternoons, evenings, weekdays, weekends, work days, holidays, or other blocks of time as the user of the methods and systems determine are necessary. In FIG. 5A, during the periods where the multipurpose lane 500 is designated a HOV/HOT lane, the monitoring station 501 associated with the lane 500 is active and perform the functions described herein. In FIG. 5B, during periods when the multipurpose lane 500 is not designated as a HOV/HOT lane, the monitoring station 501 may be deactivated or the data collected from the monitoring station 501 may be discarded or flagged. Because the methods and systems may be controlled electronically, the need to place physical barriers may be unnecessary.

In another embodiment, the designation of a multipurpose lane as an HOV/HOT lane or a non-HOV/HOT lane may be based on factors other than time. By way of example and not meant to be limiting, HOV/HOT lane designation may be based on anticipated construction, traffic disruptions, or effects on traffic patterns caused by special events.

In yet another embodiment, decoy monitoring stations (i.e., “dummy” stations) can also be deployed to increase deterrence.

The system may also be used to ensure that tolls on a HOT facility are properly assessed for those vehicles that may have passed a toll-collection sensor after entering the controlled lane at a prohibitive location.

In one embodiment, the set of monitoring stations comprises toll sensors, located at entry/exit points to the managed lanes, and toll confirmation sensors, located strategically along the corridor between the entry/exit points. Sensor bundles may include presence detection equipment and positive vehicle identification equipment and a variety of alternative technologies. Presence detectors may include, but are not limited to, video detection sensors, embedded magnetic sensors, radar sensors, etc. Examples of positive vehicle identification sensors and systems may include, but are not limited to, license plate recognition, gantry-mounted or pavement-embedded short range radio frequency identification, remote 802.11 transmission, dedicated short-range communications, cellular communications, and satellite communications. The system can be comprised of as many monitoring stations as necessary to discourage vehicles from dodging in and out of the HOV/HOT lanes or other controlled lanes.

In one embodiment, notification of the status of a controlled lane or a multipurpose lane may be conveyed to drivers of vehicles through a plurality of methods including but not limited to posting signs, displaying information on the roadway surface, displaying messages on variable message signs along the roadway, displaying messages on in-vehicle systems, hand-held devices, or displaying messages on Internet websites.

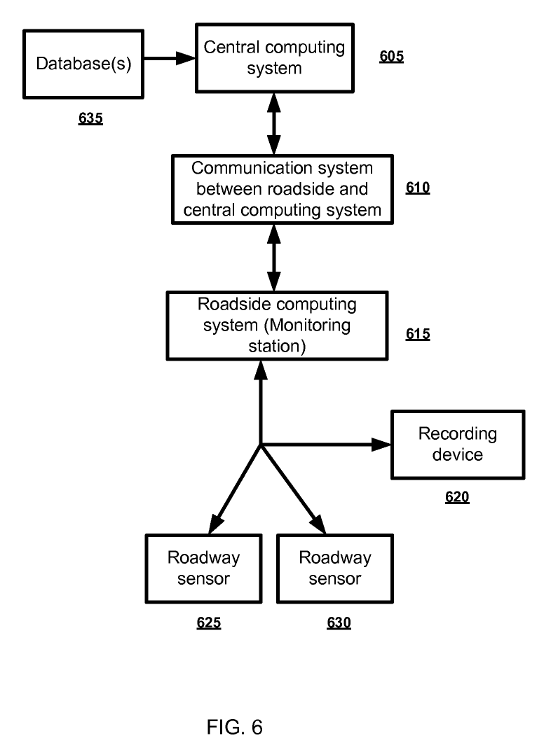

FIG. 6 illustrates an exemplary block diagram describing some logical components of the system, according to one embodiment. The overall system is controlled by a central computing system 605 that, among other tasks, determines when the monitoring stations for a given lane in a roadway should be activated. The central computing system 605 may also receive data from the monitoring stations and recording devices to determine what action is necessary. Actions may include but are not limited to issuing citations for making improper lane changes or adjusting accounts associated with HOT functions. The central computing system 605 may be operably connected to a plurality of databases 635 containing various information such as, but not limited to, vehicle identification, driver identification and commuter credit account databases. The central computing system 605 receives through a communication system 610 data from a roadside computing system 615. In one embodiment, the roadside computing system 615 receives data from a plurality of roadway sensors 625, 630 and may also control the associated recording device 620. In other embodiments, the associated recording device 620 may be controlled by the roadway sensors 625, 630 receiving instructions to record the identity of a vehicle and relaying the information to either the roadway sensors 625, 630 and/or the roadside computing system 615.

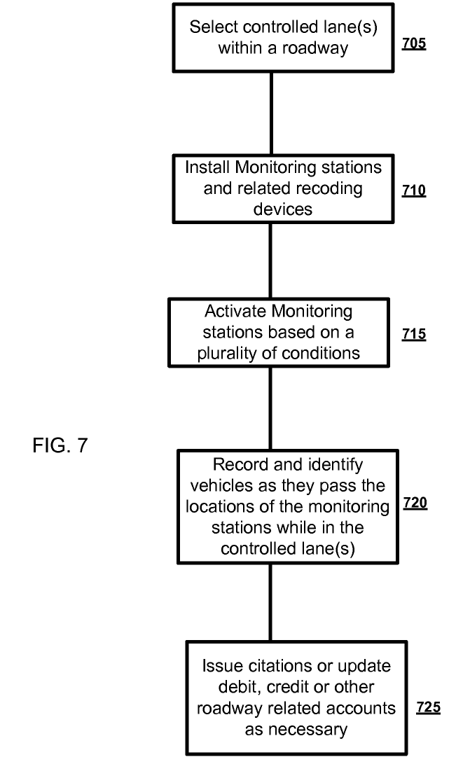

FIG. 7 illustrates an exemplary flow chart describing the steps needed to implement the method used by the system, according to one embodiment. In step 705, a determination is made concerning which lanes in a roadway are to be designated as a controlled lane. In step 710, the lanes in the roadway selected to be controlled lanes are fitted with the electronic barrier system. The system may then be activated or deactivated based on a plurality of conditions, in step 715. As vehicles pass the location of monitoring stations, in step 720, the vehicle may be identified and the information recorded. In step 725, the recorded information is used to issue citations or update debit, credit or other roadway related accounts as warranted.

In another embodiment, the methods and systems may be used for the monitoring and collection of tolls as part of a toll gantry network. As illustrated in FIG. 3, the toll gantry network may be comprised of toll paying stations 350, 360 located at entry/exit points 205, 215 along a corridor and a plurality of confirmation monitoring stations 222 located strategically throughout the corridor between the entry/exit points 205, 215. If the vehicle 301 is recorded by the tolling system as not having entered the HOT lane by properly passing under an entry toll paying station 350, but other intermediate monitoring stations 222 detect the vehicle 301, then the tolling system may record the identity of the vehicle for possible citation. Vehicle identification may be achieved with either a violation enforcement camera taking photograph of the vehicle's license plate and/or by the reading the of the vehicle's transponder. Once identified, the vehicle may be recorded as having evaded the toll by improperly crossing the double white lines and a toll citation may be issued.

Note, while FIG. 2 and FIG. 3 show the recording devices 203, 213, 223, 233, 243 located in the center median barrier, this is not required to practice the methods and systems described herein. The recording devices may be placed in a plurality of locations as long as they are aligned such that they record the identity of the vehicle as it passes the location of the monitoring station. For non-limiting examples, the recording device may be embedded into the roadway or it may be deployed on overhanging gantries or bridges.

Embodiments of a commuter credits system may work in conjunction with embodiments of an HOV/HOT electronic barrier and enforcement system and method, as described above, to positively identify an individual, vehicle, or to positively identify a specific commuter credit account (CCA), from/to which credits may be debited or credited. By way of example and not meant to be limiting, in one embodiment, as part of a toll gantry network, a commuter credits system may be utilized to assist in the management of toll collection. Each CCA may be correlated to a registered individual or an anonymous account in an administrative database. Participants in the commuter credit program may include registered owners of vehicles, designees of the registered owner, passengers who are registered in carpools or ride-share programs, passengers of mass transit systems, or any other qualified person, as defined by the operational rules of an implemented embodiment of a commuter credits system.

In one embodiment, individuals may initiate CCA credit transactions by telecommuting from a remote location. These individuals may be positively identified by a variety of means, including but not limited to, pre-registration of their computer IP and/or MAC addresses. In this embodiment, computer IP and/or MAC addresses may be validated in a variety of ways. By way of example and not meant to be limiting, IP and/or MAC addresses may be tracked with monitoring systems or sensors configured to read participant identification numbers at remote computers or business locations.

In another embodiment, a variety of means may be implemented to link a participant to their CCA for the purposes of issuing or redeeming commuter credits. By way of example and not meant to be limiting, a commuter may be issued a magnetic strip card, or transponder, or radio frequency identification (RFID) key fob, or other technology that allows a unique identification code to be transferred to a remote reader upon the occurrence of any activity which may generate a need to access the commuter's account. As a non-limiting example, a transit card with a unique ID linked to a participant's account allows the card to be identified every time the user takes the transit, which may then allow a specific number of commuter credits to be deposited in the participant's account accordingly.

In one embodiment, transit cards may link transit users to specific CCA's either electronically by contact or by contact-less methods (e.g., slide card or transponder card) for credit accrual or credit redemption. In another embodiment, an individual's CCA may be linked with a registered vanpool or any other kind of commuting alternative program.

In another embodiment, a Tollway Card (or any equivalent toll-pass card or device) may be linked to a CCA. Commuter travel may be identified by a variety of means, including, but not limited to, monitoring technology deployed along the corridor such as the electronic barrier system described herein, slide card machines at toll plazas, transponder stations, manual self-reporting means, geodetic position systems (GPS), or by any other electronic means. Once the travel is identified, the linked CCA may be debited with applicable tolls, which may also be discounted by carpool rates or by other incentives, and, when applicable, the CCA may be credited in accordance with a prescribed schedule.

In one embodiment, the prescribed schedule may be devised to further any kind of travel program or commute policy by crediting or debiting a participant's CCA accordingly. Credits may be issued or deducted to reward or to discourage participants for certain commute choices. Examples of such policies include, but are not limited to, transacting CCA credits or debits for an individual's participation in carpooling or ride-share programs, for their travel or absence of travel during prescribed times of day, for their travel or absence of travel during low and high volume traffic periods, for their travel or absence of travel during road construction, or any commute choice as it pertains to a pre-defined pattern of travel. Other possible program schedules may provide CCA credits to participants who commute by transit, vanpool, carpool, bicycle, walking, or by any other approved alternative means; or to one who commutes to an alternate work site that is closer to their residence than the primary work site, or who telecommutes from home or any other location; or who uses any other type of approved alternative means to eliminate or reduce their commute during peak traffic periods.

In one embodiment, participation in the commuter program may be optional, such that program schedules are implemented that may only reward participants for not contributing to traffic congestion. In another embodiment, participation in the commuter program may be required of all commuters and certain driving habits may be discouraged as well as encouraged. By way of example and not meant to be limiting, a prescribed schedule may be devised that would require payment of CCA credits from a commuter who chooses to commute alone, or commute during peak traffic times, or commute during road construction, in an effort to discourage the commuter's contribution to traffic congestion.

As participants make commute choices, credits may be added to, or deducted from, their CCA in accordance with a program schedule. The methods and systems recited herein enable embodiments of a commuter credits program to provide for a flexible means for participants to pay for transportation costs, to enjoy discounted costs, or to access other reward incentives.

In one embodiment, CCA credits may be applied toward toll fees. A specific number of commuter credits may be redeemed to allow a user to pass through a toll zone without paying the toll. Drivers may be notified of the number of required commuter credits to be redeemed in lieu of toll fees. This notification may be communicated to drivers via variable message signs over one or more lanes of the roadway, or through optional in-vehicle monitoring systems, by hand-held devices, or by other communication method or device. Toll fees may be calculated and automatically deducted or assessed in a commuter's CCA. In one embodiment, drivers may opt to electronically pay the toll or redeem credits in lieu of toll fees. The election may be confirmed to the driver via an Internet connection, cellular phone, or by in-vehicle or independent display device. Drivers may be automatically issued an electronic receipt for their toll payments, displaying information such as toll expense, commuter credit balance or any other related accounting information.

In another embodiment, CCA credits may be applied toward user fees for the HOT lanes. CCA credits may also be applied as vouchers for parking fees, or converted into gasoline cards, transit fares, gift cards, cash, or other products or services.

In one embodiment, toll fees may be dynamically calculated based upon factors such as time of day, volume of traffic, commuter choices, presence of road construction, or any other pre-defined variable that can be monitored. Flexible toll fees can provide an additional incentive, or disincentive, to commute during certain times or under certain conditions. By way of example and not meant to be limiting, toll fees could be increased during peak traffic times or peak traffic congestion. Additionally, toll fees may be calculated based upon commuter patterns of travel. For instance, discounts may be assessed for commuters who choose to carpool, or fees may be raised for those who do not.

In one embodiment, the commuter credits may be equally dynamic in that the number of credits either required or issued per commute event may change based upon time, upon traffic conditions, or upon any other scheme or rule, so that the implementing agency can encourage or discourage participation in the commute events.

In yet another embodiment, the system may provide flexibility in the conversion of credits to benefits, such that the number of credits required to receive a certain benefit may be varied to either encourage or discourage use of that benefit. By way of example and not meant to be limiting, any benefit in short supply may be increased in cost in order to lower its demand and preserve its supply. As a further, non-limiting example, a policy may be implemented that requires participants to redeem twice as many credits for commuting over a certain portion of roadway during the most congested 15-minute time period as may be required for commuting the roadway during the least congested 15-minute time period.

In one embodiment, commuter credits can be redeemed in a variety of different ways. By way of example and not meant to be limiting, programs may be designed through which commuter credits may be redeemed as payment towards or for discounts on automobile registration, parking fees, rental cars, transit passes, gasoline cards, airfares, gift cards, or any number of incentive programs aimed at providing an economic benefit to the owner of the commuter credit. In one embodiment, a commuter credit trading program may be implemented to facilitate the sale and exchange of credits among participants. Individuals who earn commuter credits may be allowed to buy credits from and sell credits to other participants, or donate credits to charity, or barter with credits for other goods or services, or otherwise exchange credits with one another as a fungible currency.

Each application of a commuter credits system may be developed in accordance with a variety of rules, which may be based upon policy goals, administrative capabilities, traffic studies, budget constraints, the availability of technology, or any other design consideration. Each system may be uniquely developed according to local factors, needs and goals. Such factors include, but are not limited to, an assessment of travel demand by highway segment, corridor level travel analysis, peak hour travel demand and managed lane capacity, market surveys, consumer response, or business plan development based upon analysis of customer service and marketing needs. Additionally, each system may incorporate regional, state, or national policies, either as mandated by laws or as encouraged by any influencing device.

By way of example and not meant to be limiting, regional policy goals based upon public opinion may dictate that the local commuter credit system should not provide any mechanism through which drivers are positively identified in the implementation of the program. In such a case, CCA's may be linked to a debit card that contains no identification data, so that participants need only to present the card to the system to access their credits, without ever having to identify them. As discussed above, the system and mechanism through which a commuter credit system is implemented may vary significantly in form and function in order to meet the unique goals of any region.

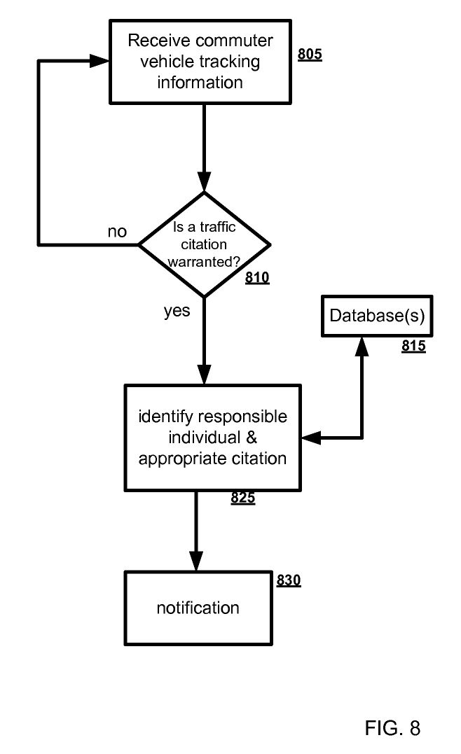

FIG. 8 illustrates an exemplary flow chart describing some steps to implement the method used by the commuter credit program to issue traffic citations, according to one embodiment. In step 805, commuter information is received from a commuter tracking system, such as, for example, the electronic barrier system described herein, among other tracking systems. The information, in step 810, is decoded, extracting among other information, the identification of the vehicle and the approximate location of one or more lane changes. If a traffic citation or toll is warranted, various databases 815 are used to determine the person or people responsible for the vehicle and the appropriate citation or toll to be issued, in step 825. The responsible person or people and appropriate regulating agencies are notified of the citation or toll, in step 830. The citation or toll can be automatically or manually deducted from a related commuter credits account.

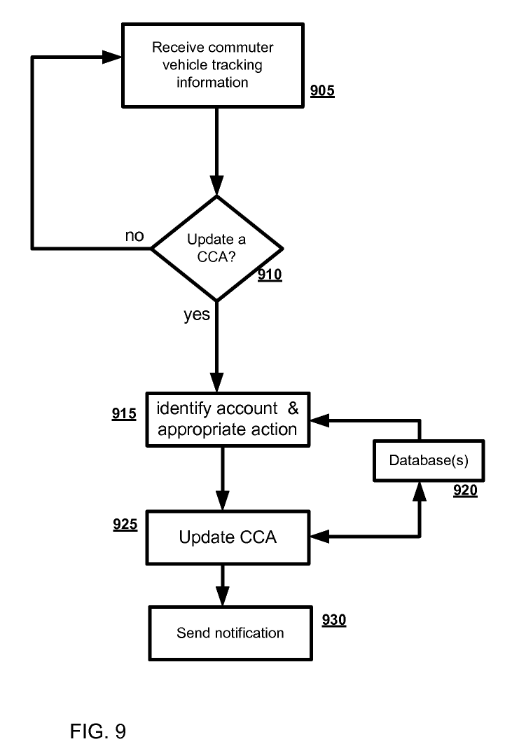

FIG. 9 illustrates an exemplary flow chart describing steps to implement a method used by the commuter credit program to update CCAs, according to one embodiment. In step 905, commuter information is received from a commuter tracking system, such as, for example, the electronic barrier system described herein, among other tracking systems. The information, in step 910, is decoded, extracting among other information, the identification of the vehicle and the approximate location of one or more lane changes. If an update to a CCA is warranted, various data bases 920 are used to determine the CCA and the appropriate action(s) to be taken, in step 915. In step 925, the database and CCA are updated with the appropriate information such as debiting or crediting the CCA for various activities or patterns of travel of the vehicle. A notification to the person or people associated with the CCA is sent in step 930.

Note, the steps described in FIG. 8 and FIG. 9 may be implemented independently or in combination. For non-limiting examples, the method described in FIG. 8 may be implemented in parallel with the method described in FIG. 9, or the two methods may be implemented serially.

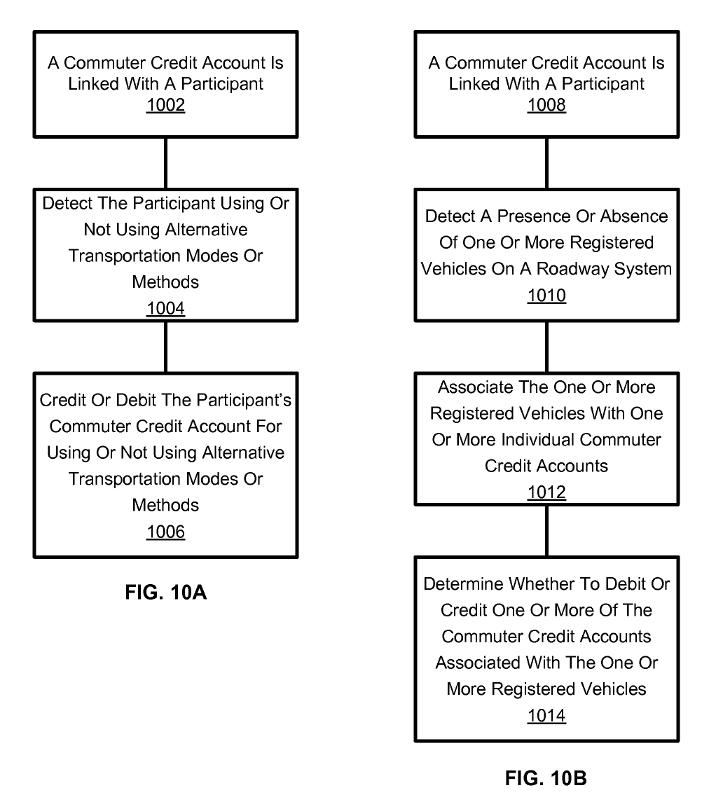

FIG. 10A is a flowchart that illustrates the steps of managing a commuter credit account according to one embodiment. At step 1002, a commuter credit account is linked with a participant. Such linking can occur electronically, such as, for example, through the use of a database, including, but not limited to, a relational database. In one aspect, the linking comprises pre-registration of individual commuter credit accounts with vehicle identification numbers or implementation of in-vehicle sensors configured for reading account numbers for each participant using the registered vehicle. By way of example and not meant to be limiting, a carpool or vanpool could be associated with a number of passengers that are not the registered owner of the vehicle. The participants could receive, or have taken, commuter credits based upon the detection of the presence of the vehicle(s) associated with the carpool or vanpool at certain periods, travel conditions, weather conditions, etc. At step 1004, the participant is detected using, or not using, alternative transportation modes or methods. Such alternative transportation modes or methods can include, but are not limited to alternative transportation modes (e.g., carpools, vanpools, transit, etc.), commuting to work during off-peak or uncongested periods, participating in telecommuting or remote worksite programs, or participating in other approved programs designed to reduce travel during peak traffic periods of the day. At step 1006, the participant's commuter credit account is debited or credited depending on whether the participant is detected using, or not using, alternative transportation modes or methods

FIG. 10B is a flowchart that illustrates the steps for implementing tracking that facilitates participant identification for association with a commuter credit account to/from which commuter credits can be credited or debited, according to one embodiment. At step 1008, a commuter credit account is linked with a participant. Such linking can occur electronically, such as through the use of a database, including, but not limited to, a relational database. In one aspect, the linking comprises pre-registration of individual commuter credit accounts with vehicle identification numbers or implementation of in-vehicle sensors configured for reading account numbers for each participant using the registered vehicle. By way of example and not meant to be limiting, a carpool or vanpool could be associated with a number of passengers that are not the registered owner of the vehicle. The participants could receive, or have taken, commuter credits based upon the detection of the presence of the vehicle(s) associated with the carpool or vanpool at certain periods, travel conditions, weather conditions, etc. At step 1010, a registered vehicle's presence or absence on a roadway is determined or detected. By way of example and not meant to be limiting, the electronic barrier system described herein could be used to determine a vehicles presence or absence in designated lanes of traffic. Likewise, other methods of tracking can be employed such as the use of geodetic positioning systems (GPS), as are known in the art. At step 1012, the registered vehicle is associated with one or more individual commuter credit accounts. At step 1014, it is determined, based upon pre-defined parameters and the presence or absence of the vehicle on the roadway, whether to credit or debit one or more individual commuter credit accounts associated with the vehicle.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as examples only, with a true scope and spirit being indicated by the following claims.

What is claimed is:

1. An electronic commuter credits system comprising:
a processor;
an electronic barrier system comprising at least a plurality of sensing devices located in series along one or more lanes of travel of a roadway system operably connected to the processor, wherein said electronic barrier system is configured to detect a presence or absence of a vehicle in said one or more lanes of travel of a roadway system and positively identify the vehicle; and
a memory, wherein commuter credits are assessed to a registered owner of the vehicle or a passenger in the vehicle, or tolls or fees are assessed to the registered owner of the vehicle or a passenger in the vehicle based upon patterns of travel of the vehicle and said commuter credits are stored in the memory in a commuter credits account associated with an individual.

2. The system of claim 1, wherein the commuter credits can be redeemed to pay the tolls and fees.

3. The system of claim 1, wherein the commuter credits can be redeemed for access to mass transit systems.

4. The system of claim 1, wherein the commuter credits can be redeemed for cash.

5. The system of claim 1, wherein the tolls or fees are increased based upon pre-defined patterns of travel.

6. The system of claim 5, wherein the pre-defined patterns of travel comprise travel between certain times of day.

7. The system of claim 5, wherein the pre-defined patterns of travel comprise travel during high vehicle traffic congestion.

8. The system of claim 5, wherein the pre-defined patterns of travel comprise travel during road construction.

9. The system of claim 1, wherein the commuter credits are issued to the registered owner of the vehicle or a passenger in the vehicle based upon participation in a car pool.

10. The system of claim 1, wherein the commuter credits are issued to the registered owner of the vehicle or a passenger in the vehicle based upon pre-defined patterns of travel.

11. The system of claim 10, wherein the pre-defined patterns of travel comprise travel between certain times of day.

12. The system of claim 10, wherein the pre-defined patterns of travel comprise travel during low vehicle traffic congestion.

13. The system of claim 10, wherein the pre-defined patterns of travel comprises absence of travel between certain times of day.

14. The system of claim 10, wherein the pre-defined patterns of travel comprises absence of travel during high vehicle traffic congestion.

15. The system of claim 10, wherein the pre-defined patterns of travel comprises absence of travel during road construction.

16. The system of claim 1, further comprising allocating commuter credits to an individual's commuter credits account in the memory based upon use of commuting alternatives.

17. The system of claim 16, wherein the commuting alternatives include telecommuting, commuting by bicycle, walking, or commuting to an alternative work site closer to an individual's residence.

18. The system of claim 1, wherein the tolls and fees are automatically assessed in the memory against an individual's commuter credits account.

19. The system of claim 1, wherein the vehicle is a mass transit vehicle.

20. The system of claim 1, wherein the vehicle is a vehicle associated with a registered carpool.

21. The system of claim 1, wherein individuals can buy, sell, donate or otherwise exchange commuter credits with one another and said exchanges are stored in the memory.

22. The system of claim 1, further comprising:
a transportation operations database that comprises roadway segment information including one or more electronic barrier entry points and corresponding electronic barrier exit points, roadway operating conditions, and roadway segment toll price; and
a vehicle registration database that links vehicle identity information to a registered vehicle owner, a registered carpool ID, a transit vehicle ID, or with an account that allows an anonymous account-holder to make toll payments, fee payments or redeem commuter credits;
wherein the vehicle identity information is compared to the vehicle registration database to determine the registered owners of the one or more vehicles in the one or more lanes of the roadway system, participants in a carpool or passengers in a transit vehicle and to issue tolls, fees or consumer credits to the registered vehicle owner of the one or more vehicles in the one or more lanes of the roadway system, participants in the carpool or passengers in the transit vehicle.

23. The system of claim 22, wherein the commuter credits are issued to the registered owner of the vehicle or a passenger in the vehicle based upon participation in a car pool.

24. The system of claim 22, wherein the commuter credits are issued to the registered owner of the vehicle or a passenger in the vehicle based upon participation in a mass transit vehicle.

25. A method of tracking that facilitates participant identification for association with a commuter credit account to which commuter credits can be credited or debited, said method comprising:
linking a commuter credit account with a participant, wherein said linking comprises pre-registration of individual commuter credit accounts with vehicle identification numbers or implementation of in-vehicle sensors configured for reading account numbers for each participant using said vehicle;
identifying the vehicle on a roadway or the absence of the vehicle on the roadway;
associating the vehicle with one or more individual commuter credit accounts; and
determining, based upon pre-defined parameters and the presence or absence of the vehicle on the roadway, whether to credit or debit one or more individual commuter credit accounts associated with the vehicle.

26. The method of claim 25, further comprising identifying when a participant is telecommuting from a remote location and crediting or debiting the participant's individual commuter credit account based upon whether the participant is telecommuting from a remote location.

27. The method of claim 26, wherein identifying when a participant is telecommuting from a remote location comprises pre-registration of individual computer IP addresses with computer monitoring systems or the implementation of sensors configured to read participant identification numbers at remote computers or business locations.

28. The method of claim 25, wherein determining, based upon pre-defined parameters and the presence or absence of the vehicle on the roadway, whether to credit or debit one or more individual commuter credit accounts associated with the vehicle comprises crediting or debiting one or more individual commuter credit accounts associated with a vehicle based upon the vehicle's presence or absence on the roadway between certain times of day.

29. The method of claim 25, wherein determining, based upon pre-defined parameters and the presence or absence of the vehicle on the roadway, whether to credit or debit one or more individual commuter credit accounts associated with the vehicle comprises crediting or debiting one or more individual commuter credit accounts associated with a vehicle based upon the vehicle's presence or absence on the roadway during high traffic or during low traffic congestion.

30. The method of claim 25, wherein determining, based upon pre-defined parameters and the presence or absence of the vehicle on the roadway, whether to credit or debit one or more individual commuter credit accounts associated with the vehicle comprises crediting or debiting one or more individual commuter credit accounts associated with a vehicle based upon a participant's use of commuting alternatives.

31. The method of claim 30, wherein the commuting alternatives include telecommuting, commuting by bicycle, walking, or commuting to an alternative work site closer to an individual's residence.

32. The method of claim 25, wherein the vehicle is a mass transit vehicle.

33. The method of claim 25, wherein the vehicle is a vehicle associated with a registered carpool.

34. The method of claim 25, wherein determining, based upon pre-defined parameters and the presence or absence of the vehicle on the roadway, whether to credit or debit one or more individual commuter credit accounts associated with the vehicle, the number of commuter credits earned as a function of monitored activity can be varied as a function of prescribed policy goals or in accordance with a system of decision rules designed to optimize system performance, toll revenues, or other goals.

35. The method of claim 25, further comprising notifying a driver of the vehicle of a toll, and a required number of credits to be redeemed in lieu of paying a toll by communicating to the driver via variable message signs over one or more lanes of the roadway and to optional in-vehicle monitoring systems.

36. The method of claim 35, wherein the driver can electronically elect to either pay the toll or redeem credits in lieu of toll payment, and where the election is later confirmed to the driver via an Internet connection, cellular phone, or any variety of other in-vehicle display systems.

37. The method of claim 36, wherein a receipt for toll payments of redemption of commuter credits can be automatically issued electronically to participants.

38. The method of claim 25, wherein commuter credits are fungible, enabling commuter credits to be purchased, sold, or traded upon approval of a managing authority.

39. A method of managing a commuter credit account comprising:
linking a commuter credit account with a participant;
detecting the participant using or not using alternative transportation modes or methods; and
crediting or debiting the participant's commuter credit account based upon the participant's using, or not using, alternative transportation modes or methods.

40. The method of claim 29, wherein detecting the participant using or not using alternative transportation modes or methods comprises detecting the participant using or not using carpools, vanpools, public transit, commuting to work during off-peak or uncongested periods, or participating in telecommuting or remote worksite programs.
